(19) United States
(12) Patent Application Publication
(10) Pub. No.: US 2026/0002265 A1
(43) Pub. Date: Jan. 1, 2026

(54) ENAMEL-COATED STAINLESS STEEL PRODUCT, PRODUCTION METHOD, AND FLOWMETER

(71) Applicant: Endress+Hauser Flowtec AG, Reinach (CH)

(72) Inventors: Julien Zimmermann, Neuenhof (CH); Aaron Egger, Bärschwil (CH)

(21) Appl. No.: 18/995,515

(22) PCT Filed: Jun. 5, 2023
(86) PCT No.: PCT/EP2023/064981

§ 371 Date: Jan. 16, 2025

(30) Foreign Application Priority Data
Jul. 29, 2022 (DE) 10 2022 119 143.5

(51) Int. Cl. C23D 3/00; C22C 19/05; C22C 19/07; C23C 4/08; C23C 4/123; C23C 24/08; C23C 24/10; C23D 5/00; G01F 1/58

(52) U.S. Cl. CPC C23D 3/00; C22C 19/05; C22C 19/07; C23C 4/08; C23C 4/123; C23C 24/085; C23C 24/106; C23D 5/00; G01F 1/58

(57) ABSTRACT

The present disclosure relates to a stainless steel product comprising a stainless steel sheet. On a surface of the stainless steel sheet an adhesion promoter is applied. The adhesion promoter comprises a CoCr and/or NiCr alloy, wherein and on the adhesion promoter an enamel coating is applied. The present disclosure also relates to a magnetic-inductive flow meter, to a field device and to a method for producing a stainless steel product.

The invention relates to a stainless steel product, to a magnetic-inductive flow meter, to a field device and to a method for producing a stainless steel product.

In automation, particularly in process automation, field devices serving to capture and/or modify process variables are frequently used. For detecting process variables, sensors that are integrated, for example, into fill-level measuring devices, flow meters, pressure and temperature measuring devices, pH-redox potential meters, conductivity meters, etc., are used to detect the respective process variables, such as fill-level, flow, pressure, temperature, pH level, or conductivity. Actuators, such as, for example, valves or pumps, are used to influence process variables. The flow rate of a fluid in a pipeline section or a fill-level in a container can thus be altered by means of actuators. In principle, all devices which are process-oriented and which supply or process process-relevant information are referred to as field devices. In connection with the invention, “field devices” therefore also refer to remote I/Os, radio adapters, or, in general, electronic measuring components that are disposed at the field level.

A field device is in particular selected from a group consisting of flow meters, fill level measuring devices, pressure measuring devices, temperature measuring devices, limit level measuring devices and/or analytical measuring devices.

Flow meters are, in particular, Coriolis, ultrasound, vortex, thermal and/or magnetically-inductive flow meters.

Fill-level measuring devices are, in particular, microwave fill-level measuring devices, ultrasonic fill-level measuring devices, time-domain reflectometry measuring devices, radiometric fill-level measuring devices, capacitive fill-level measuring devices, inductive fill-level measuring devices and/or temperature-sensitive fill-level measuring devices.

Pressure-measuring devices are, in particular, absolute, relative, or differential-pressure devices.

Temperature measuring devices are, in particular, measuring devices with thermocouples and/or temperature-dependent resistors.

Limit level-measuring devices are, in particular, vibronic limit level measuring devices, ultrasonic limit level measuring devices and/or capacitive limit level measuring devices.

Analytical measuring devices are, in particular, pH sensors, conductivity sensors, oxygen and active oxygen sensors, (spectro-)photometric sensors, and/or ion-selective electrodes.

Magnetic-inductive flow meters are used for determining the flow rate and the volumetric flow of a flowing medium in a pipeline. A distinction is made here between in-line magnetic-inductive flow meters and magnetic-inductive flow measuring probes, which are inserted into a lateral opening of a pipeline. A magnetic-inductive flow meter has a device for producing a magnetic field, which produces a magnetic field perpendicularly to the flow direction of the flowing medium. Single coils are typically used for this purpose. In order to realize a predominantly homogeneous magnetic field, pole shoes are additionally formed and attached such that the magnetic field lines run over the entire pipe cross section substantially perpendicularly to the transverse axis or in parallel to the vertical axis of the measuring pipe. In addition, a magnetic-inductive flow meter has a measuring pipe on which the device for producing the magnetic field is arranged. A measuring electrode pair attached to the lateral surface of the measuring pipe taps an electrical measurement voltage or potential difference which is applied perpendicularly to the direction of flow and to the magnetic field and occurs when a conductive medium flows in the direction of flow when the magnetic field is applied. Since, according to Faraday's law of induction, the tapped measurement voltage depends on the velocity of the flowing medium, the flow rate and, with the inclusion of a known pipe cross section, the volumetric flow can be determined from the induced measurement voltage.

In contrast to a magnetic-inductive flow meter, which comprises a measuring pipe for conducting the medium with an attached device for generating a magnetic field penetrating the measuring pipe and with measuring electrodes, magnetic-inductive flow measuring probes are inserted with their usually circular cylindrical housings into a lateral opening of a pipeline and fixed in a fluid-tight manner. A special measuring pipe is no longer necessary. The measuring electrode arrangement and coil arrangement, mentioned in the introduction, on the lateral surface of the measuring pipe are omitted and are replaced by a device for producing a magnetic field, which device is arranged in the interior of the housing and in direct proximity to the measuring electrodes and is designed such that an axis of symmetry of the magnetic field lines of the produced magnetic field perpendicularly intersects the front face or the face between the measuring electrodes. In the prior art, there is already a plurality of different magnetic-inductive flow measuring probes.

Magnetic-inductive flow meters are often used in process and automation engineering for fluids, starting from an electrical conductivity of approximately 5 μS/cm. Corresponding flow measurement devices are sold by the applicant in a wide variety of embodiments for various fields of application, for example under the name PROMAG or MAGPHANT.

The use of enameled pipes and pipelines in the chemical and pharmaceutical industries and in drinking water supplies is already known. In the chemical and pharmaceutical industries, pipelines are coated with multiple layers of enamel to provide a sufficiently chemically resistant corrosion protection layer. The material of the pipelines is usually a carbon steel such as P 235 G1 TH. For drinking water supply, cast iron pipelines are used which are coated on the inside with only a single layer of enamel. Adhesion between the enamel coating and the carbon steel or cast iron is usually very good. When using stainless steel, enameling is usually not necessary. On the one hand, the stainless steel itself is often sufficiently corrosion-resistant and on the other hand, the adhesion between stainless steel and enamel is very poor and not suitable for most applications.

The object of the invention is to remedy this problem.

The object is achieved by the stainless steel product according to claim 1, the magnetic-inductive flow meter according to claim 10, the field device according to claim 11 and the method according to claim 15.

The stainless steel product according to the invention comprises:

a stainless steel sheet,
wherein on a surface of the stainless steel sheet an adhesion promoter is applied,
wherein the adhesion promoter comprises a Ni alloy, in particular NiCr alloy, and/or Co alloy, in particular CoCr alloy,
wherein on the adhesion promoter an enamel coating is applied.

The term “stainless steel” is subject to EN 10020 and is a designation for alloyed or unalloyed steels with a particular degree of purity. One requirement, for example, would be that the sulfur and phosphorus content must not exceed 0.025% by mass.

As defined in the patent application, an adhesion promoter is an intermediate layer which ensures that the adhesion of the second coating applied to the intermediate layer is improved. The adhesion promoter is often much thinner than the second coating to be bonded, in this case the enamel coating.

Enamel refers to a mass of inorganic composition, usually consisting of silicates and oxides, which is produced by melting, fritting or sintering (which means a melting process that is interrupted shortly before complete melting) in a mostly glassy solidified form. This mass is applied, sometimes with additives, usually in one or more layers to a carrier material and melted at high temperatures for a short firing time, usually with the aim of coating the carrier material. (see enamel: Wikipedia, Apr. 20, 2022 [online] https://de.wikipedia.org/wiki/Email [May 20, 2022]).

Advantageous embodiments of the invention are the subject matter of the dependent claims.

One embodiment provides that the adhesion promoter has a nominal layer thickness d_{Haft},
wherein for the layer thickness d_{Haft} the following applies: 10≤d_{Haft}≤500 μm, in particular 30≤d_{Haft}≤300 μm and preferably 75≤d_{Haft}≤200 μm.

One embodiment provides that the adhesion promoter has a Cr content of at least 10 mass percent, in particular at least 15 and at most 45 mass percent, in particular at most 40 mass percent.

One embodiment provides that the adhesion promoter has a Ni content of at least 30 mass percent, in particular at least 40 mass percent and at most 80 mass percent, in particular at most 75 mass percent.

One embodiment provides that the adhesion promoter has a Co content of at least 30 mass percent, in particular at least 40 mass percent and at most 80 mass percent, in particular at most 75 mass percent.

One embodiment provides that the enamel coating has a nominal layer thickness d_{Email},
wherein for the layer thickness d_{Email} the following applies: 0.1≤d_{Email}≤3 mm, in particular 0.5≤d_{Email}≤2.5 m and preferably 1≤d_{Email}≤2.2.

One embodiment provides that the enamel coating meets the requirements of ISO 28721-1 (2019 September), in particular with regard to the layer thickness.

ISO 28721-1 specifies the quality requirements for apparatuses, components, appliances and accessories made of enameled steel (including semi-crystallized enamel coatings) and cast steel used for process plants.

One embodiment provides that the adhesion promoter is applied by means of a thermal spraying process (DIN EN 657), a powder coating process or a cold gas spraying process.

One embodiment provides that the surface has a mean roughness Ra according to DIN EN ISO 4287:2010, for which the following applies: Ra≥1 μm, in particular Ra≥5 μm and preferably Ra≥10 μm.

The mean roughness is a measure of the roughness of a surface, which describes the unevenness of a surface height. The mean roughness indicates the average distance of a measuring point to the center line of a reference distance. The roughness on the surface is standardized in EN ISO 25178 (2020).

The magnetic-inductive flow meter according to the invention for determining a flow-rate-dependent measured variable of a flowable medium comprises:

a measuring pipe for guiding a medium,
wherein the measuring pipe comprises, at least in sections, a stainless steel product according to at least one of the preceding claims,
wherein the enamel coating is electrically insulating,
   a magnetic field-generating device for generating a magnetic field that penetrates the measuring pipe; and
   a device for tapping off a measurement voltage induced in the flowable medium.

When using electrically conductive measuring pipes, it is essential to prevent them from coming into contact with the conductive medium by means of a so-called liner. The liner is an electrically insulating body which covers the inside of the measuring pipe and partly also regions of the connection body (e.g., flange). The use of enamel as a liner is already known from EP 60 87 93 A2 and DE 19 705 436 A1. However, the use of enamel as a liner in conjunction with measuring pipes made of or comprising stainless steel sheet is not yet known.

The use of Inconel pipes for MID applications is also known. U.S. Pat. No. 3,750,468A can be cited as an example. A disadvantage of using Inconel pipes is the magnetic property of nickel. This can be reduced by mixing with chromium and carbon, but the reduction also depends on the operating temperature of the magnetic-inductive flow meter. According to the invention, no Inconel pipes are used, but a CoCr and/or NiCr alloy is provided as a thin layer between the stainless steel sheet and the enamel coating.

The field device according to the invention for determining a measured variable of a medium comprises:

a component, in particular one in contact with the medium,
wherein the component comprises, at least in sections, a stainless steel product according to the invention; and
   a device for determining the measured variable of a medium.

Advantageous embodiments of the invention are the subject matter of the dependent claims.

One embodiment provides that the component comprises a vibratable unit, in particular a tuning fork, or a vortex sensor flag.

One embodiment provides that the component comprises a housing and/or a measuring head.

One embodiment provides that the component comprises a measuring pipe.

The method according to the invention for producing a stainless steel product, in particular the stainless steel product according to the invention, comprises the method steps of:

applying an adhesion promoter to a surface of a stainless steel sheet,
wherein the adhesion promoter comprises a CoCr and/or NiCr alloy; and
   applying an enamel coating to the adhesion promoter.

Advantageous embodiments of the invention are the subject matter of the dependent claims.

One embodiment provides the additional method step of:

roughening the surface of the stainless steel sheet so that it has a mean roughness Ra according to DIN EN ISO 4287:2010, for which the following applies: Ra≥1 μm, in particular Ra≥5 μm and preferably Ra≥10 μm.

The surface is in this case roughened before the adhesion promoter is applied.

The invention is explained in greater detail with reference to the following figures. In the drawings:

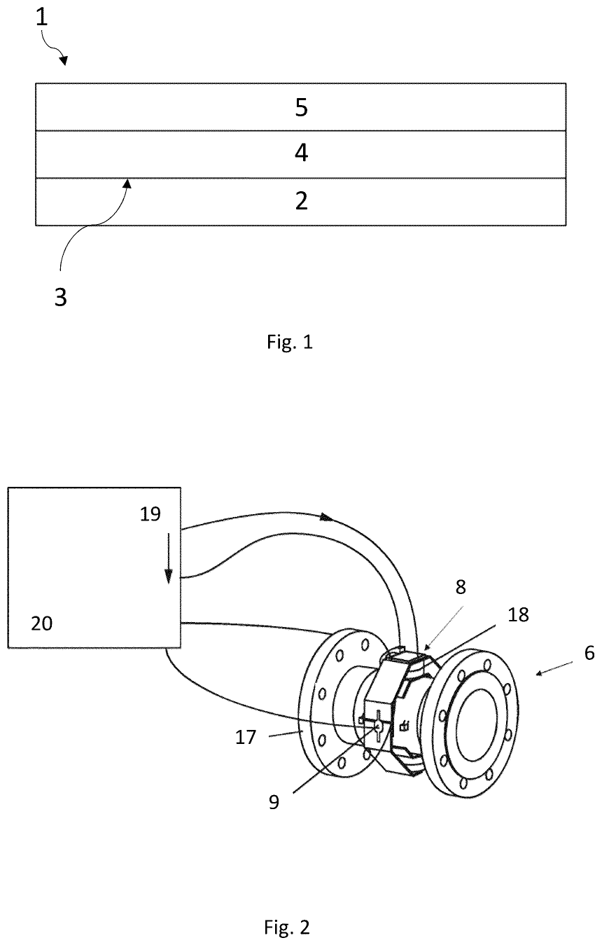

FIG. 1 shows a cross section through an embodiment of the stainless steel product according to the invention,

FIG. 2 shows an embodiment of the magnetic-inductive flow meter according to the invention;

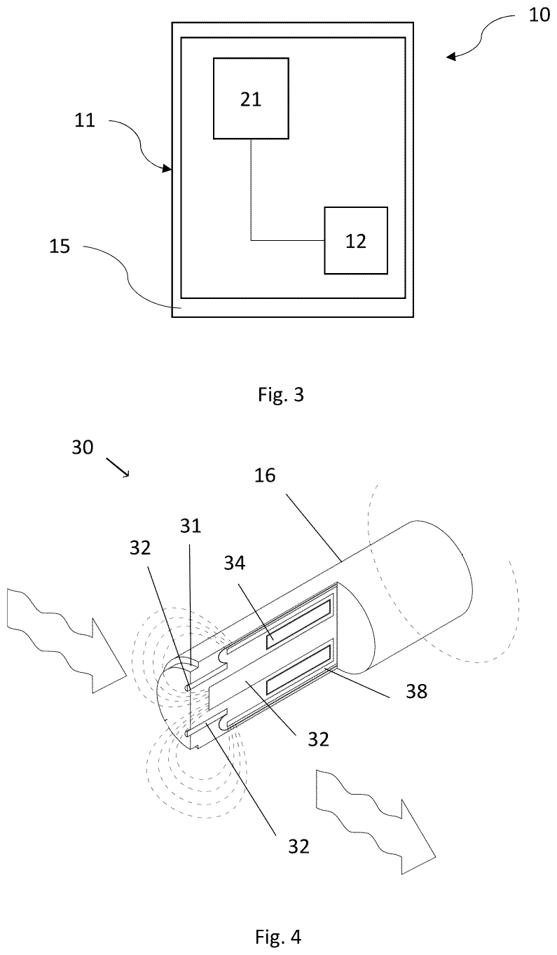

FIG. 3 shows an embodiment of the field device according to the invention;

FIG. 4 shows a further embodiment of the field device according to the invention;

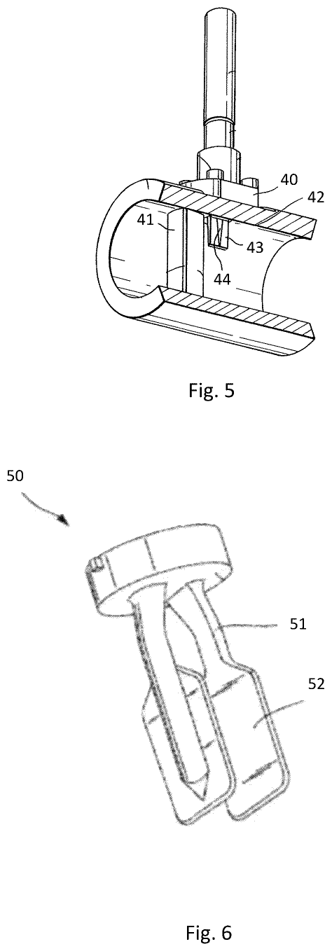

FIG. 5 shows a further embodiment of the field device according to the invention; and

FIG. 6 shows a further embodiment of the field device according to the invention.

FIG. 1 shows a cross section through an embodiment of the stainless steel product 1 according to the invention. The stainless steel product 1 comprises a stainless steel sheet 2 according to EN 10027. The stainless steel sheet 2 can be flat or bent. A suitable stainless steel sheet 2 has, for example, a material number of 1.4003, 1.4006, 1.4016, 1.4021, 1.4104, 1.4301, 1.4305, 1.4306, 1.4307, 1.4452, 1.4462 or 1.4429. The stainless steel sheet 2 has a surface 3 with a mean roughness Ra according to DIN EN ISO 4287:2010, for which the following applies: Ra≥1 μm, in particular Ra≥5 μm and preferably Ra≥10 μm. By adjusting the roughness of the surface 3 of the stainless steel product, the adhesion of the enamel can be improved. The roughness results from the production method for the stainless steel sheet (e.g., hot or cold rolling) or can be adjusted by an additional roughening method, such as grinding or sandblasting.

On the surface 3 of the stainless steel sheet 2, an adhesion promoter 4 is applied. This serves to improve the adhesion of an enamel coating 5 on the stainless steel sheet 2. The adhesion promoter 4 comprises a NiCr alloy. According to the invention, the adhesion promoter 4 may additionally or alternatively comprise a CoCr alloy. The adhesion promoter 4 is applied to the surface 3 by means of a thermal spraying process. This comprises plasma spraying, high-velocity fuel spraying, vacuum plasma spraying or flame spraying. Alternatively, the adhesion promoter 4 can also be applied by means of a powder coating process or a cold gas spraying process. A galvanic or vacuum-based coating process, such as physical vapor deposition or chemical vapor deposition, is less suitable. The adhesion promoter 4 has a nominal layer thickness d_{Haft} for which the following applies: 10≤d_{Haft}≤500 μm, in particular 30≤d_{Haft}≤300 μm and preferably 75≤d_{Haft}≤200 μm.

The enamel coating 5 is applied to the adhesion promoter 4 in such a way that a substantially continuous coating is formed which completely covers the adhesion promoter 4, at least in sections. One of the thermal spraying processes mentioned above is also suitable for this purpose. Alternatively, the enamel coating 5 can also be applied by means of a powder coating process or a cold gas spraying process. The enamel coating 5 has a nominal layer thickness d_{Email} for which the following applies: 0.1≤d_{Email}≤3 mm, in particular 0.5≤d_{Email}≤2.5 mm and preferably 1≤d_{Email}≤2.2 mm.

For the use of the stainless steel product 1 in process engineering plants, the enamel coating 5 is designed in such a way that the requirements of ISO 28721-1 (2019 September), in particular with regard to the layer thickness, are met.

The adhesion promoter 4 has a Cr content of at least 10 mass percent, in particular at least 15 and at most 45 mass percent, in particular at most 40 mass percent.

Furthermore, the adhesion promoter 4 has a Ni content of at least 35 mass percent, in particular at least 45 mass percent and at most 80 mass percent, in particular at most 75 mass percent.

Alternatively, the Cr content can be replaced by a Co content of at least 40 mass percent, in particular at least 50 mass percent and at most 80 mass percent, in particular at most 75 mass percent.

Examples of suitable NiCr alloys are Inconel 718 and Inconel 625. The term Inconel is a trademark of the Special Metals Corporation. Inconel refers to a superalloy that contains predominantly nickel. Additionally, the superalloy may also contain some other metals such as magnesium, iron and titanium.

Examples of suitable CoCr alloys are Alloy 188 (e.g., HAYNES 188) and Alloy L 605 (e.g., HAYNES 25). Additionally, the alloy may also contain some other metals such as nickel, magnesium, iron and silicon.

The adhesion promoter 4 is preferably selected such that its thermal expansion coefficient is greater than/equal to the thermal expansion coefficient of the stainless steel sheet and less than/equal to the thermal expansion coefficient of the enamel coating 5.

FIG. 2 shows an embodiment of the magnetic-inductive flow meter 6 according to the invention. The magnetic-inductive flow meter 6 for determining a flow-rate-dependent measured variable of a flowable medium comprises a measuring pipe 7 for guiding the flowable and conductive medium. The measuring pipe 7 comprises, at least in sections, a stainless steel product 1 according to the invention. For this purpose, a stainless steel pipe (support pipe)—which is formed, for example, at least in sections from a bent stainless steel sheet—is provided on an inner lateral surface with the adhesion promoter according to the invention (not shown) and the enamel coating 5 (see FIG. 1). The enamel coating 5 forms the liner required for a metallic support pipe. Furthermore, the enamel coating 5 is designed to be electrically insulating in order to prevent the separated charges in the medium from being discharged to the electrically conductive support pipe or stainless steel pipe. The measuring pipe 7 also comprises a connection device on each of the two end faces of the support pipe. The connection device shown is a flange 17. However, a plurality of alternative connection devices are also known. A magnetic field-generating device 8 for generating a magnetic field that penetrates the measuring pipe 7 is arranged on an outer lateral surface of the measuring pipe 7. The magnetic field-generating device 8 can comprise a single coil 18, a coil system comprising several coils 18 or at least one permanent magnet. Furthermore, the magnetic field-generating device 8 can comprise components for guiding the magnetic field. The coil or coils can each comprise a coil core. If at least two coils, each with one coil core, are provided, the coil cores can be connected to each other via field guide plates. Furthermore, a device 9 for tapping off a measurement voltage induced in the medium is provided. The device 9 for tapping off the measurement voltage induced in the medium comprises at least one measuring electrode. This is arranged in an opening in the measuring pipe 7 in contact with the medium. Usually, at least two diametrically arranged measuring electrodes are provided, which are arranged on the measuring pipe in such a way that a measuring electrode axis intersecting the two measuring electrodes and a main field axis of the generated magnetic field intersect perpendicularly. The magnetic field-generating device 8 is connected to an electronic unit. The latter comprises an operating circuit 19 for operating the magnetic field-generating device 8 with a drive signal. Furthermore, the electronic unit comprises a measuring circuit 20 which is configured to determine a measurement voltage applied to the device 9. The electronic unit is configured to determine the flow-rate-dependent measured variable based upon the measured measurement voltage.

Alternatively or additionally, a housing (not shown) made at least in sections from stainless steel can be provided which encloses the magnetic field-generating device 8 and the measuring pipe 7 in a cross section through the magnetic-inductive flow meter 6 and which, according to the invention, has the adhesion promoter and the enamel coating in accordance with FIG. 1.

The magnetic-inductive flow meter 6 shown is an example of a field device according to the invention, the component of which that is in contact with the medium corresponds to a measuring pipe 7 which at least in sections comprises the stainless steel product 1 according to the invention.

FIG. 3 shows an embodiment of the field device 10 according to the invention. The field device 10 for determining a measured variable of a medium, in particular a flowable medium, comprises a component 11, in particular one in contact with the medium, which comprises, at least in sections, a stainless steel product according to the invention. The component 11 shown is a housing 15 for accommodating an electronic unit 21 and/or a device 12 for determining the measured variable of a medium. The device 12 for determining the measured variable of the medium can comprise at least one sensor, in particular a temperature sensor, vibration sensor, pressure sensor, conductivity sensor, pH sensor, capacitive sensor and/or an antenna, in particular a microwave antenna and/or an optical detector and/or a sound transducer. The field device 10 can also be a thermocouple which has a casing made of the stainless steel product according to the invention as a housing.

FIG. 4 shows a further embodiment of the field device according to the invention. The field device shown is a magnetic-inductive flow measuring probe 30 which is arranged in a lateral opening of a pipeline in contact with the medium and which is configured to determine the flow rate of the flowing medium. The magnetic-inductive flow measuring probe 30 comprises a measuring head 16 that is in contact with the medium and in which the magnetic field-generating device 38 is arranged. The magnetic field-generating device 38 comprises exactly one coil 33, a coil core 34 and a field guiding device. In a front portion of the measuring head 16, an electrically insulating front body 31 is arranged in/on which two measuring electrodes 32 are attached.

The measuring head 16 is formed at least in sections from a stainless steel sheet which has an adhesion promoter and enamel coating according to the invention. The magnetic-inductive flow measuring probe 30 is an exemplary field device which has a measuring head 16 which is in contact with the medium and which comprises the stainless steel sheet according to the invention. Other field devices are known which have a measuring head which is in contact with the medium and which comprises, at least in sections, the stainless steel product according to the invention.

FIG. 5 shows an embodiment of the field device according to the invention. The field device shown is a vortex flow meter 40. A generic vortex flow meter 40 is described, for example, in “Durchfluss-Handbuch,” 4th edition, 2003, ISBN 3-9520220-3-9, p. 103 et seq. or in EP1556670A1. Generic vortex flow meters 40 are based on the fact that vortexes are shed alternately from both sides of a bluff body 41 around which a fluid flows in a measuring pipe 42 and form what is known as a Kármán vortex street, wherein the vortexes lead to periodic pressure fluctuations which are to be detected with a vortex detector 43. For a concrete measuring arrangement, the shedding frequency of the vortexes is substantially proportional to the flow rate and the Strouhal number, a dimensionless number. The flow rate or the volumetric flow rate can thus be ascertained in a simple manner by ascertaining the vortex frequency. The vortex detector of the vortex flow meter 40 shown comprises a sensor flag 44 which comprises, at least in sections, the stainless steel product according to the invention.

FIG. 6 shows a further embodiment of the field device according to the invention. The field device shown is a vibronic limit level meter 50. This device is used as a fill-level measuring device and often has a tuning fork 52 as a vibratable unit 51. However, variants with a single rod or a membrane have also become known. During operation, the vibratable unit 51 is excited by means of an electromechanical transducer unit to mechanical oscillations which in turn can be provided, for example, by a piezoelectric drive or an electromagnetic drive. It goes without saying that in addition to the examples mentioned, there are other possibilities which also fall under the present invention.

A wide variety of corresponding field devices are made by the applicant and, in the case of fill-level measuring devices, are distributed under the name LIQUIPHANT and/or SOLIPHANT, for example. The underlying measurement principles are known from numerous publications. The excitation of the vibratable unit 51 can be carried out using both analog and digital methods and is usually carried out via an analog electrical oscillating circuit. The electromechanical transducer unit excites the vibratable unit 51 to mechanical oscillations by means of an electrical excitation signal and receives the oscillations and converts them into an electrical reception signal. The electromechanical transducer unit accordingly comprises either a separate drive and receiving unit or a combined drive/receiving unit. The drive/receiving unit is in this case part of a control circuit integrated into an electronic unit, which control circuit normally adjusts the excitation signal such that a predeterminable phase shift is present between the excitation signal and received signal.

### LIST OF REFERENCE SIGNS

Stainless steel product 1
Stainless steel sheet 2
Surface of the stainless steel product 3
Adhesion promoter 4
Enamel coating 5
Magnetic-inductive flow meter 6
Measuring pipe 7
Magnetic field-generating device 8
Device for tapping off a measurement voltage induced in the medium 9
Field device 10
Component 11
Device for determining the measured variable of a medium 12
Tuning fork 13
Vortex paddle 14
Housing 15
Measuring head 16
Flange 17
Coil 18
Operating circuit 19
Measuring circuit 20
Electronic unit 21
Magnetic-inductive flow measuring probe 30
Front body 31
Measuring electrode 32
Coil 33
Coil core 34
Magnetic field-generating device 38
Vortex flow meters 40
Bluff body 41
Measuring pipe 42
Vortex detector 43
Sensor flag 44
Vibronic limit level meters 50
Vibratable unit 51
Tuning fork 52

1-15. (Canceled)

16. A stainless steel product, comprising:
a stainless steel sheet;
wherein on a surface of the stainless steel sheet an adhesion promoter is applied;
wherein the adhesion promoter comprises a Ni alloy;
wherein on the adhesion promoter an enamel coating is applied.

17. The stainless steel product according to claim 16,
wherein the adhesion promoter has a nominal layer thickness d_{Haft};
wherein for the layer thickness d_{Haft} the following applies: 10≤d_{Haft}≤500 μm.

18. The stainless steel product according to claim 16,
wherein the adhesion promoter has a Cr content of at least 10 mass percent.

19. The stainless steel product according to claim 16,
wherein the adhesion promoter has a Ni content of at least 35 mass percent and at most 80 mass percent.

20. The stainless steel product according to claim 16,
wherein the adhesion promoter has a Co content of at least 40 mass percent and at most 80 mass percent.

21. The stainless steel product according to claim 16,
wherein the enamel coating has a nominal layer thickness d_{Email},
wherein for the layer thickness d_{Email} the following applies: 0.1≤d_{Email}≤3 mm, in particular 0.5≤d_{Email}≤2.5 m and preferably 1≤d_{Email}≤2.2 mm.

22. The stainless steel product according to claim 16,
wherein the enamel coating meets the requirements of ISO 28721-1 (2019 September) with regard to the layer thickness.

23. The stainless steel product according to claim 16,
wherein the adhesion promoter is applied by means of a thermal spraying process, a powder coating process or a cold gas spraying process.

24. The stainless steel product according to according to claim 16,
wherein the surface has a mean roughness Ra according to DIN EN ISO 4287:2010, for which the following applies: Ra≥1 μm.

25. A magnetic-inductive flow meter for determining a flow-rate-dependent measured variable of a flowable medium, comprising:
a measuring pipe for guiding a medium;
wherein the measuring pipe comprises, at least in sections, a stainless steel product;
wherein the stainless steel product includes a stainless steel sheet, wherein on a surface of the stainless steel sheet an adhesion promoter is applied, wherein the adhesion promoter comprises a Ni alloy, wherein on the adhesion promoter an enamel coating is applied;
wherein the enamel coating is electrically insulating;
a magnetic field-generating device for generating a magnetic field that penetrates the measuring pipe; and
a device for tapping off a measurement voltage induced in the medium.

26. A field device for determining a measured variable of a medium, comprising:
a component in contact with the medium;
wherein the component comprises, at least in sections, a stainless steel product;
wherein the stainless steel product includes a stainless steel sheet, wherein on a surface of the stainless steel sheet an adhesion promoter is applied, wherein the adhesion promoter comprises a Ni alloy, wherein on the adhesion promoter an enamel coating is applied; and
a device for determining the measured variable of a medium.

27. The field device according to claim 26,
wherein the component comprises a vibratable unit, a tuning fork, or a vortex sensor flag.

28. The field device according to claim 26,
wherein the component comprises a housing and/or a measuring head.

29. The field device according to claim 26,
wherein the component comprises a measuring pipe.

30. A method for producing a stainless steel product including a stainless steel sheet,
wherein on a surface of the stainless steel sheet an adhesion promoter is applied,
wherein the adhesion promoter comprises a Ni alloy, wherein on the adhesion promoter an enamel coating is applied, the method comprising the method steps of:
applying an adhesion promoter to a surface of a stainless steel sheet;
wherein the adhesion promoter comprises a CoCr and/or NiCr alloy; and
applying an enamel coating to the adhesion promoter.
